(19) United States
(12) Patent Application Publication
(10) Pub. No.: US 2025/0299891 A1
(43) Pub. Date: Sep. 25, 2025

(54) ROTARY THOMSON COIL ACTUATOR FOR 2- AND 3-PHASE ULTRA-FAST CIRCUIT INTERRUPTERS

(71) Applicant: EATON INTELLIGENT POWER LIMITED, DUBLIN 4 (IE)

(72) Inventors: Santhosh Kumar Chamarajanagar Govinda Nayaka, Moon Township, PA (US); Robert Michael Slepian, Murrysville, PA (US); Xin Zhou, Wexford, PA (US)

(73) Assignee: EATON INTELLIGENT POWER LIMITED, DUBLIN 4 (IE)

(21) Appl. No.: 19/084,913

(22) Filed: Mar. 20, 2025

Related U.S. Application Data
(60) Provisional application No. 63/567,561, filed on Mar. 20, 2024.

(51) Int. Cl. H01H 3/26

(52) U.S. Cl. CPC H01H 3/26

(57) ABSTRACT

A rotary Thomson coil actuator for use in a multi-pole circuit interrupter is provided and includes: an insulating cylinder, a plurality of pole assemblies, and a number of Thomson coil arrangements. Each pole assembly includes two stationary conductors and one rotating conductive arm. Each stationary conductor includes a stationary contact. The rotating conductive arm is fixedly coupled to the insulating cylinder and includes two movable contacts, with each movable contact corresponding to one of the stationary contacts. Each Thomson coil arrangement includes a conductive plate, a first Thomson coil, and a second Thomson coil. The conductive plate is fixedly coupled to the insulating cylinder, and the two Thomson coils face opposing sides of the conductive plate. The opposing orientations of the two Thomson coils relative to the conductive plate results in the repulsion force exerted by each of the two coils on the conductive plate being additive.

### CROSS REFERENCE TO RELATED APPLICATIONS

This patent application claims the priority benefit of U.S. Provisional Patent Application Ser. No. 63/567,561, filed Mar. 20, 2024, entitled, “Rotary Thomson Coil Actuator For 2- And 3-Phase Ultra-Fast Circuit Interrupters”, the contents of which are incorporated by reference.

### FIELD OF THE INVENTION

The disclosed concept relates generally to circuit interrupters, and in particular, to actuation mechanisms used to open and close separable contacts in hybrid circuit interrupters.

### BACKGROUND OF THE INVENTION

Circuit interrupters, such as for example and without limitation, those used in circuit breakers, are typically used to protect electrical circuitry from damage due to an overcurrent condition, such as an overload condition, a short circuit, or another fault condition, such as an arc fault or a ground fault. Circuit interrupters typically include mechanically separable electrical contacts, which operate as a switch. When the separable contacts are in contact with one another in a closed state, current is able to flow through any circuits connected to the circuit interrupter. When the separable contacts are isolated from one another in an open state, current is prevented from flowing through any circuits connected to the circuit interrupter. The separable contacts may be operated either manually by way of an operator handle or automatically in response to a detected fault condition. Typically, such circuit interrupters include an actuator designed to rapidly close or open the separable contacts, and a trip mechanism, such as a trip unit, which senses a number of fault conditions to trip the separable contacts open automatically using the actuator. Upon sensing a fault condition, the trip unit trips the actuator to move the separable contacts to their open position.

Hybrid circuit interrupters employ a power electronic (PE) interrupter in addition to the mechanical separable contacts. The power electronic interrupter is connected in parallel with the mechanical contacts, and comprises electronics structured to commutate current after a fault is detected. Once current is commutated from the mechanical switch to the power electronic interrupter, the mechanical separable contacts are able to separate with a reduced risk of arcing. It is advantageous to commutate as much current as possible to the electronic branch as quickly as possible and to open the mechanical separable contacts at high speeds in order to limit the let-through current during a fault condition.

When it is desired to implement hybrid PE circuit interrupting devices in a smaller form factor, the hybrid PE device can be difficult to implement in a smaller package due to the significant mass of the movable mechanical components. In addition, the packaging for a smaller form factor can cause severe thermal issues for the PE components.

There is thus room for improvement in mechanisms used to open separable contacts in hybrid circuit interrupters.

### SUMMARY OF THE INVENTION

These needs and others are met by embodiments of a rotary Thomson coil actuator for use in a multi-pole circuit interrupter. The rotary Thomson coil actuator includes: an insulating cylinder, a plurality of pole assemblies, and a number of Thomson coil arrangements. Each pole assembly includes two stationary conductors and one rotating conductive arm. Each stationary conductor includes a stationary contact. The rotating conductive arm is fixedly coupled to the insulating cylinder and includes two movable contacts, with each movable contact corresponding to one of the stationary contacts. Each Thomson coil arrangement includes a conductive plate, a first Thomson coil, and a second Thomson coil. The conductive plate is fixedly coupled to the insulating cylinder, and the two Thomson coils face opposing sides of the conductive plate. The opposing orientations of the two Thomson coils relative to the conductive plate results in the repulsion force exerted by each of the two coils on the conductive plate being additive.

In one exemplary embodiment of the disclosed concept, a rotary Thomson coil actuator is provided for use in a multi-pole circuit interrupter having a plurality of poles. The rotary Thomson coil actuator comprises: an insulating cylinder; a plurality of pole assemblies disposed between a line side and a load side of the rotary Thomson coil actuator, and a number of Thomson coil arrangements. Each pole assembly comprises: two stationary conductors, each stationary conductor being fixed in space and including a stationary contact; and one rotating conductive arm, the rotating conductive arm being fixedly coupled to the insulating cylinder and comprising two movable contacts, with each movable contact corresponding to one of the stationary contacts. The number of Thomson coil arrangements is one less in quantity than the plurality of pole assemblies, with each Thomson coil arrangement comprising: a conductive plate, the conductive plate being fixedly coupled to the insulating cylinder; and two Thomson coils including a first Thomson coil and a second Thomson coil, the two Thomson coils being fixed in space and facing the conductive plate. The insulating cylinder is configured to rotate between a closed position and an open position, the closed position being a position in which all of the movable contacts are in physical and electrical contact with their corresponding stationary contacts, and the open position being a position in which all of the movable contacts are physically separated and electrically isolated from their corresponding stationary contacts. Each Thomson coil arrangement is structured such that the conductive plate moves away from the two Thomson coils when at least one of the two Thomson coils is energized with current. Each Thomson coil arrangement is structured such that energizing the Thomson coils with current causes the insulating cylinder to rotate from the closed position to the open position.

In another exemplary embodiment of the disclosed concept, a circuit interrupter with a plurality of poles structured to be connected between a power source and a load comprises: an electronic trip unit and a rotary Thomson coil actuator. The rotary Thomson coil actuator comprises: an insulating cylinder; a plurality of pole assemblies disposed between a line side and a load side of the rotary Thomson coil actuator, and a number of Thomson coil arrangements. Each pole assembly comprises: two stationary conductors, each stationary conductor being fixed in space and including a stationary contact; and one rotating conductive arm, the rotating conductive arm being fixedly coupled to the insulating cylinder and comprising two movable contacts, with each movable contact corresponding to one of the stationary contacts. The number of Thomson coil arrangements is one less in quantity than the plurality of pole assemblies, with each Thomson coil arrangement comprising: a conductive plate, the conductive plate being fixedly coupled to the insulating cylinder; and two Thomson coils including a first Thomson coil and a second Thomson coil, the two Thomson coils being fixed in space and facing the conductive plate. The insulating cylinder is configured to rotate between a closed position and an open position, the closed position being a position in which all of the movable contacts are in physical and electrical contact with their corresponding stationary contacts, and the open position being a position in which all of the movable contacts are physically separated and electrically isolated from their corresponding stationary contacts. The electronic trip unit is configured to energize all of the Thomson coils in the rotary Thomson coil actuator when a fault condition is detected in any of the poles. Each Thomson coil arrangement is structured such that the conductive plate moves away from the two Thomson coils when at least one of the two Thomson coils is energized with current. The rotary TC arrangement is structured such that energizing at least one of the Thomson coils with current causes the insulating cylinder to rotate from the closed position to the open position.

### BRIEF DESCRIPTION OF THE DRAWINGS

A full understanding of the invention can be gained from the following description of the preferred embodiments when read in conjunction with the accompanying drawings in which:

FIG. 1 is a partial isometric view of the top and sides of a rotary Thomson coil actuation arrangement for use in a multi-pole circuit interrupter (with some components being omitted from FIG. 1 and instead being shown in FIGS. 2A-2B and FIGS. 3A-3B), shown as a 2-pole embodiment, in accordance with an example embodiment of the disclosed concept;

FIG. 2A is a rotated partial isometric view of the top and sides of the rotary Thomson coil actuation arrangement shown in FIG. 1 (with some components being omitted from FIG. 2A and instead being shown in FIG. 1) with the separable contacts of the two poles in a closed state, in accordance with an example embodiment of the disclosed concept;

FIG. 2B is a side elevation view of the arrangement shown in FIG. 2A;

FIG. 3A shows the same view of the rotary Thomson coil actuation arrangement shown in FIG. 2A with the separable contacts of the two poles in an open state, in accordance with an example embodiment of the disclosed concept;

FIG. 3B is a side elevation view of the arrangement shown in FIG. 3A;

FIG. 4 is a partial isometric view of the top and sides of a portion of another rotary Thomson coil actuation arrangement for use in a multi-pole circuit interrupter (with some components being omitted for simplicity), shown as a 3-pole embodiment, in accordance with another example embodiment of the disclosed concept;

FIG. 5 is a block diagram of a multi-pole hybrid circuit interrupter in which the rotary Thomson coil actuation arrangement shown in FIGS. 1-3B is implemented, in accordance with an example embodiment of the disclosed concept;

FIG. 6A is a symbolic diagram of the hybrid switch assembly of the circuit interrupter shown in FIG. 5 during normal operation of the circuit interrupter;

FIG. 6B is a symbolic diagram of the hybrid switch assembly of the circuit interrupter shown in FIG. 5 after completion of a first stage of current interruption;

FIG. 6C is a symbolic diagram of the hybrid switch assembly of the circuit interrupter shown in FIG. 5 after completion of current interruption through the hybrid switch assembly;

FIG. 6D is a symbolic diagram of the hybrid switch assembly of the circuit interrupter shown in FIG. 5 after completion of galvanic isolation of the pole assembly in which the hybrid switch assembly is disposed;

FIG. 7A is a partial sectional view of a prior art linear motion Thomson coil actuator, with the separable contacts in a closed state; and

FIG. 7B shows the prior art linear motion Thomson coil actuator shown in FIG. 7A, with the separable contacts in an open state.

### DETAILED DESCRIPTION OF THE INVENTION

Directional phrases used herein, such as, for example, left, right, front, back, top, bottom and derivatives thereof, relate to the orientation of the elements shown in the drawings and are not limiting upon the claims unless expressly recited therein.

As employed herein, the statement that two or more parts or components are “coupled” shall mean that the parts are joined or operate together either directly or indirectly, i.e., through one or more intermediate parts or components, so long as a link occurs. As used herein, “directly coupled” means that two elements are directly in contact with each other. As used herein, “fixedly coupled” or “fixed” means that two components are coupled so as to move as one while maintaining a constant orientation relative to each other.

As employed herein, when ordinal terms such as “first” and “second” are used to modify a noun, such use is simply intended to distinguish one item from another, and is not intended to require a sequential order unless specifically stated.

As employed herein, the term “number” shall mean one or an integer greater than one (i.e., a plurality).

As employed herein, the term “processing unit” or “processor” shall mean a programmable analog and/or digital device that can store, retrieve, and process data; a microprocessor; a microcontroller; a microcomputer; a central processing unit; or any suitable processing device or apparatus.

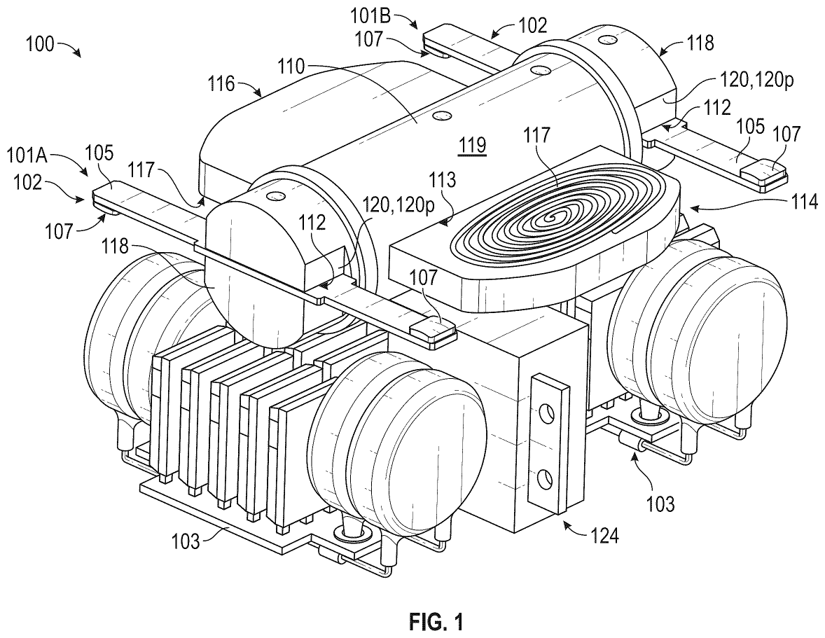

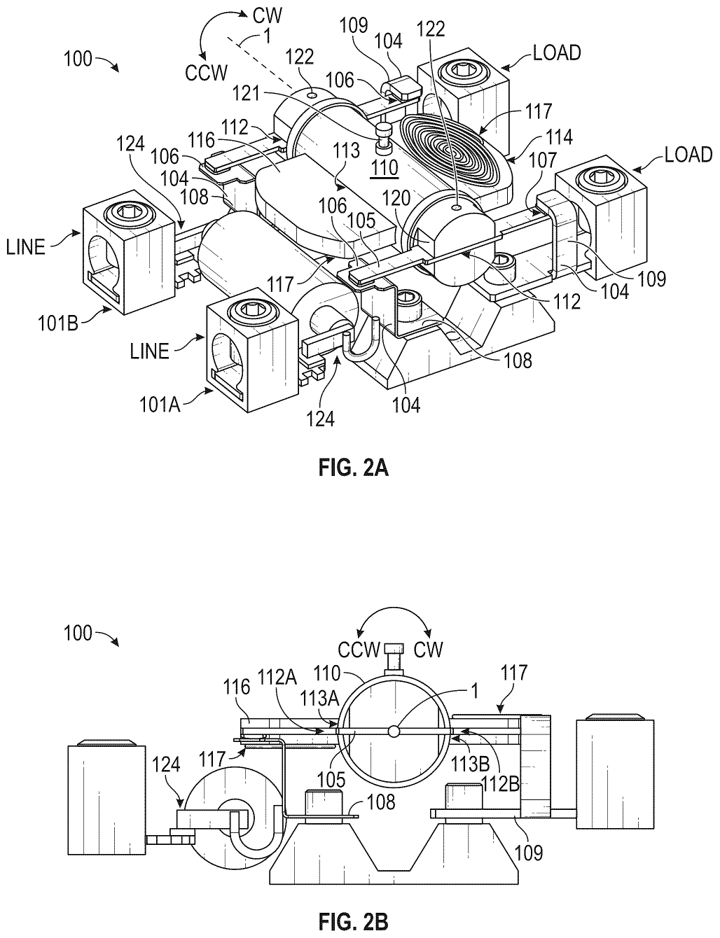

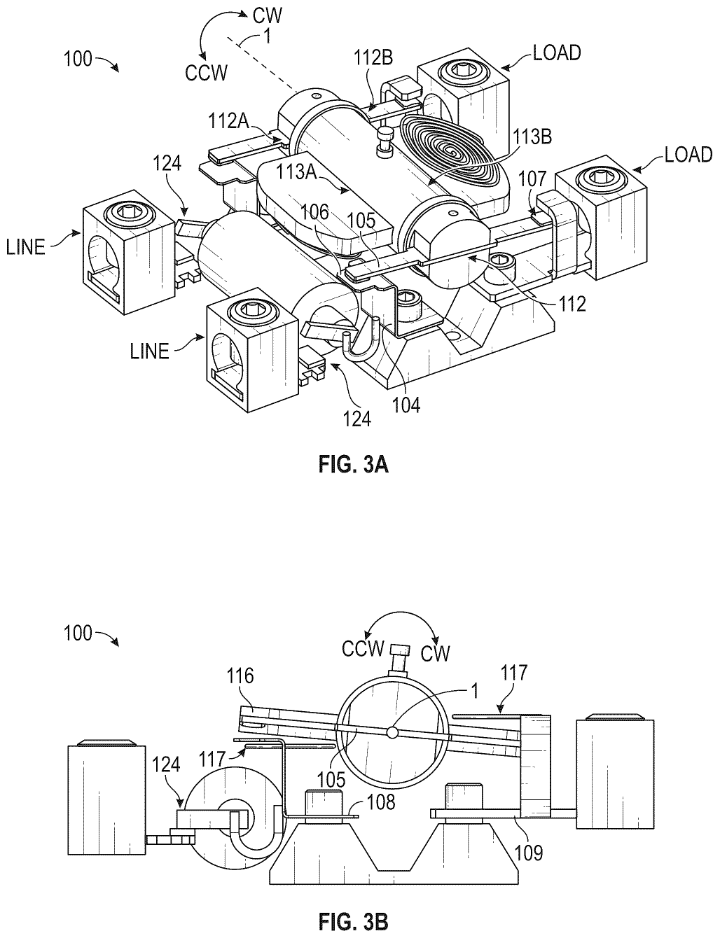

Reference is now made to FIGS. 1, 2A-2B, and 3A-3B, which show a rotary Thomson coil actuator 100 for use in a multi-pole circuit interrupter, in accordance with an example embodiment of the disclosed concept. The rotary Thomson coil actuation actuator 100 is referred to hereinafter as the rotary TC actuator 100 for brevity. For the sake of clarity and case of explanation, due to the numerous components included in the rotary TC actuator 100, some components of the rotary TC actuator 100 are only shown in FIG. 1, while some other components of the rotary TC arrangement are only shown in FIGS. 2A-2B and 3A-3B (i.e. each of FIGS. 2A-2B and 3A-3B show all of the same components). That is, it should be understood that the rotary TC actuator 100 includes all of the components shown in FIGS. 1-3B, even though some of the components shown in FIGS. 2A-3B are not shown in FIG. 1 and even though some of the components shown in FIG. 1 are not shown in FIGS. 2A-3B.

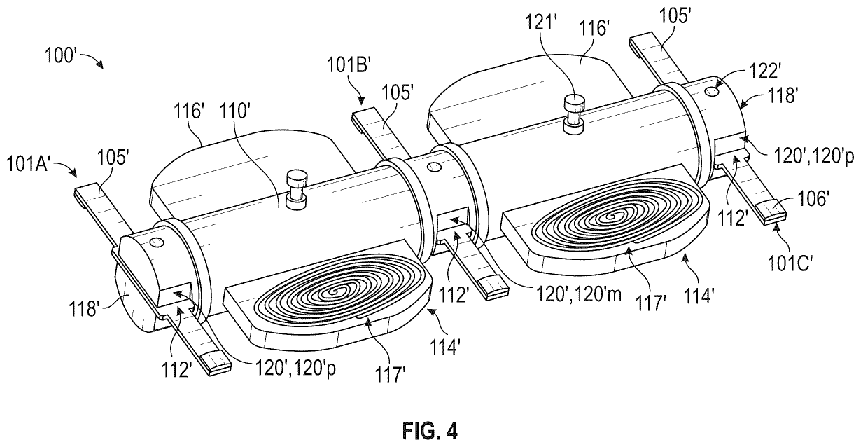

While the specific embodiment of the rotary TC actuator 100 shown in FIGS. 1-3B is a two-pole embodiment, it is noted that the rotary TC actuator 100 can easily be adapted for use with more than two poles. For example, FIG. 4 shows a three-pole embodiment 100′ of the disclosed rotary TC arrangement, in accordance with another exemplary embodiment of the disclosed concept. It will become apparent from the detailed description provided herein how the rotary TC actuator can be further adapted for use with four poles.

Both the two-pole embodiment 100 and the three-pole embodiment 100′ of the rotary TC arrangement operate using the same principles, with the sole difference between the two embodiments being that the three-pole embodiment 100′ includes a greater quantity of components than the two-pole embodiment 100. For this reason, the operating principles of the rotary TC actuator 100 will be discussed primarily referencing only the two-pole embodiment 100 for the sake of simplicity, but it should be understood that the concepts explained with reference to the two-pole embodiment also apply to the three-pole embodiment 100′. In addition, the components of the three-pole embodiment 100′ are numbered using the same reference numbers used for the two-pole embodiment 100, but with the addition of the prime symbol (i.e. “′”), and it should also be understood that each component of the three-pole embodiment 100′ functions in the same manner as the similarly numbered component of the two-pole embodiment 100.

The rotary TC actuator 100 is structured to simultaneously open the line to load connections of a plurality of poles, and thus includes two or more pole assemblies 101. The rotary TC actuator 100 shown in FIGS. 1-3B is structured for use with a two-pole circuit interrupter and includes two pole assemblies 101A and 101B. The pole assemblies 101A and 101B shown in FIGS. 1-3B may be referred to generally and collectively as the “pole assemblies 101” and any pole assembly may be referred to generally and individually as a “pole assembly 101”. In the three-pole embodiment 100′ shown in FIG. 4, the third/additional pole assembly is labeled 101C′. All pole assemblies 101 include the same types of components, and the inclusion of a letter following a reference number is used solely to emphasize that more than one pole is present in the rotary TC actuator 100, but it should be understood that same-numbered components function in the same manner in all poles.

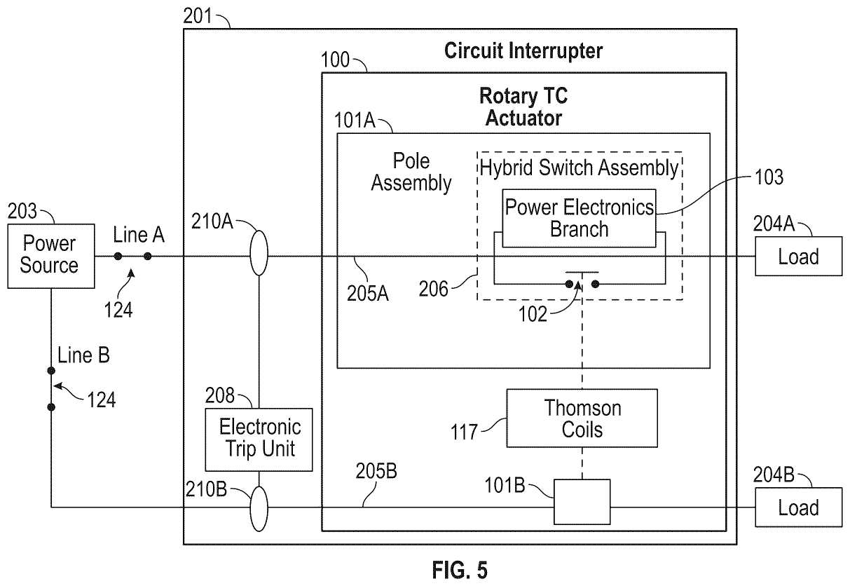

Each pole assembly 101 includes a mechanical branch 102 and a power electronics branch 103. The power electronics branch 103 comprises a number of semiconductor devices configured to be switched on and off, as detailed further later herein in conjunction with FIG. 5. The mechanical branch 102 comprises two stationary conductors 104 (shown only in FIGS. 2A-3B) and one single movable conductor 105, with each stationary conductor 104 comprising a stationary contact 106 and the movable conductor 105 comprising two movable contacts 107 (numbered only in FIG. 1). A first of the two stationary conductors 104 within each pole 101 is a line side stationary conductor 108 (numbered in FIG. 2A), and a second of the two stationary conductors 104 within each pole 101 is a load side stationary conductor 109 (numbered in FIG. 2A). For clarity of illustration, the associated stationary contacts 106 are not additionally separately numbered as line side and load side stationary contacts.

The movable conductor 105 is structured as a rotating arm, and is referred to hereinafter as the rotating conductive arm 105. For each rotating conductive arm 105, a first of the movable contacts 107 is positioned at a first end of the rotating conductive arm 105 and a second of the movable contacts 107 is positioned at a second end of the rotting conductive arm 105, the second end being disposed opposite the first end. In addition, the first movable contact 107 is positioned on a first side/surface of the rotating conductive arm 105 and the second movable contact 107 is positioned on a second side/surface of the rotating conductive arm, the second side being disposed opposite the first side.

Within each pole, each movable contact 107 corresponds to one of the stationary contacts 106, and the rotating conductive arm 105 is configured to be actuated between a closed state and an open state. In the closed state (shown in FIGS. 1 and 2A-2B), each rotating conductive arm 105 is positioned such that each movable contact 107 is in physical and electrical contact with its corresponding stationary contact 106. In the open state (shown in FIGS. 3A-3B), each rotating conductive arm 105 is positioned such that each movable contact 107 is physically separated from and electrically isolated from its corresponding stationary contact 106.

As numbered in at least FIGS. 1 and 2A, the rotary TC actuator 100 also includes an insulating cylinder 110 comprising a number of arm receiving slots 112, a number of plate receiving slots 113, and a number of Thomson coil arrangements 114 each comprising a conductive plate 116 and two Thomson coils 117. The insulating cylinder 110 can comprise, for example and without limitation, a thermoset or other high strength polymer. Being a cylinder, it will be appreciated that, in addition to comprising a longitudinal axis 1, the insulating cylinder 110 comprises two parallel bases 118 and a curved surface 119 extending between the two bases 118 (the two bases 118 and curved surface 119 only being numbered in FIG. 1).

While the overall shape of the insulating cylinder 110 is cylindrical, there are a few portions of the insulating cylinder 110 where the cross-section of the insulating cylinder 110 is not entirely circular but instead has a modified circular perimeter. For example, the two bases 118 of the insulating cylinder 110 are substantially circular, in that each base 118 has the shape of a circle in which two straight parallel cuts have been made in order to form flattened regions 120, each cut being along a non-diameter chord of the circle and extending a short distance along the length of the insulating cylinder 110. The arm receiving slots 112 are formed in the flattened regions 120, as detailed further later herein. For any embodiment of the rotary TC actuator 100 requiring more than two rotating conductive arms 105 (such as the three-pole embodiment 100′ shown in FIG. 4), the insulating cylinder 110 includes additional flattened regions 120 disposed between the two flattened regions 120 adjacent to the bases 118, and the arm receiving slots 112 in excess of the first two arm receiving slots 112 are formed in these additional flattened regions 120. The flattened regions 120 formed adjacent to the bases 118 can be referred to as peripheral flattened regions 120p (as numbered in FIG. 1), and the flattened regions 120 disposed between the flattened regions 120 can be referred to as the middle flattened regions 120m (as numbered in FIG. 4). Any combination of the peripheral flattened regions 120p and/or the middle flattened regions 120m can be referred to generally and collectively using the reference number 120, and any individual peripheral flattened region 120p or middle flattened region 120m can be referred to generally and individually using the reference number 120. Those portions of the insulating cylinder 110 where there are no flattened regions 120 can be said to have a circular cross-section, while those portions of the insulating cylinder 110 where there are flattened regions 120 can be said to have a modified circular cross-section.

Each arm receiving slot 112 is structured to receive a rotating conductive arm 105. All embodiments of the rotary TC actuator 100 comprise at least two rotating conductive arms 105, and the insulating cylinder 110 comprises as many arm receiving slots 112 as there are rotating conductive arms. A first of the arm receiving slots 112 is formed in one peripheral flattened region 120p of the insulating cylinder 110 and positioned adjacent to a first of the insulating cylinder bases 118, and a second of the arm receiving slots 112 is formed in the other peripheral flattened region 120p of the insulating cylinder 110 and positioned adjacent to a second of the insulating cylinder bases 118. Each of the first and second arm receiving slots 112 also form an opening in the respective adjacent cylinder bases 118.

In any embodiment of the rotary TC actuator 100 comprising three or more pole assemblies 101, any arm receiving slots 112 in excess of the first two arm receiving slots 112 are formed in the middle flattened regions 120m positioned along the length of the insulating cylinder 110 so that all of the arm receiving slots 112 are equidistant from one another along the length of the insulating cylinder 110. For example, in the three-pole embodiment 100′ the third arm receiving slot 112′ (i.e. the arm receiving slot 112′ that is not disposed adjacent to either insulating cylinder base 118′) is formed in the middle flattened region 120′m and is disposed an equal distance from both of the arm receiving slots 112′ that are adjacent to the insulating cylinder bases 118′. Each arm receiving slot 112 forms two openings in the surface of the insulating cylinder 110, and specifically in the flattened regions 120 (the two openings for one arm receiving slot 112 being numbered as 112A and 112B in FIGS. 2B and 3A), such that the arm receiving slot 112 extends between the two openings 112A and 112B through the modified circular cross section of the insulating cylinder 110 body so as to coincide with the longitudinal axis 1.

Each plate receiving slot 113 is structured to receive a conductive plate 116. The rotary TC actuator 100 is structured to include one less Thomson coil arrangement 114 than there are pole assemblies 101, such that there is one less conductive plate 116 than there are rotating conductive arms 105, and thus, there is one less plate receiving slot 113 than there are arm receiving slots 112. Each plate receiving slot 113 is positioned between two arm receiving slots 112 along the length of the insulating cylinder 110 so as to be equidistant from both of the arm receiving slots 112. Each plate receiving slot 113 forms two openings in the curved surface 119 of the insulating cylinder 110 (the two openings for one plate receiving slot 113 being numbered as 113A and 113B in FIGS. 2B and 3A), such that the plate receiving slot 113 extends between the two openings 113A and 113B through the circular cross section of the insulating cylinder 110 so as to coincide with the longitudinal axis 1.

Each conductive plate 116 is fixedly coupled to the insulating cylinder 110, for example and without limitation, by first inserting the conductive plate 116 into a plate receiving slot 113 and then fastening the conductive plate 116 to the insulating cylinder 110 using a fastener 121 (numbered in FIG. 2A). The fastener 121 can comprise, for example and without limitation, a rivet pin. The conductive plate 116 is disposed within the plate receiving slot 113 such that a first end of the conductive plate 116 extends out a first side (e.g. 113A in FIG. 3A) of the plate receiving slot 113 and such that a second end of the conductive plate 116 extends out a second side (e.g. 113B in FIG. 3A) of the plate receiving slot 113, with the first end of the conductive plate 116 being symmetrical with the second end of the conductive plate 116. For each conductive plate 116, the conductive plate 116 is inserted into the plate receiving slot 113 such that its length is perpendicular to the longitudinal axis 1 of the insulating cylinder 110.

Similarly, each rotating conductive arm 105 is fixedly coupled to the insulating cylinder 110, for example and without limitation, by first inserting the rotating conductive arm 105 into an arm receiving slot 112 and then fastening the rotating conductive arm 105 to the insulating cylinder 110 using a fastener 122 (numbered in FIG. 2A). The fastener 122 can comprise, for example and without limitation, a rivet pin. Each rotating conductive arm 105 is disposed within the arm receiving slot 112 such that a first end of the rotating conductive arm 105 extends out a first side (e.g. 112A in FIG. 3A) of the arm receiving slot 112 and such that a second end of the rotating conductive arm 105 extends out a second side (e.g. 112B in FIG. 3A) of the arm receiving slot 112, with the first end of the rotating conductive arm 105 being symmetrical with the second end of the rotating conductive arm 105. For each rotating conductive arm 105, the rotating conductive arm 105 is inserted into the arm receiving slot 112 such that its length is perpendicular to the longitudinal axis 1 of the insulating cylinder 110.

It will be appreciated that the rotary TC coil actuator 100 is structured to be housed within a housing of a circuit interrupter, although the housing of the circuit interrupter is not shown for the sake of clarity of illustration. This is noted because it should be understood that the Thomson coils 117 are structured to be fixedly positioned in space relative to the circuit interrupter housing when installed within the circuit interrupter housing, although the structures that keep the Thomson coils 117 fixedly positioned are not shown in the figures for clarity of illustration. In an exemplary embodiment, the rotary TC actuator 100 is structured such that each Thomson coil 117 is positioned 0.030 inches away from the corresponding conductive plate 116 when the rotating conductive arms 105 are in the closed state, in order to account for erosion of the separable contacts 106, 107 over time. More specifically, this gap is 0.030 inches when the separable contacts 106, 107 are new, and is provided to enable over travel of each movable conductor 105 as the separable contacts 106, 107 erode. The more the separable contacts 106, 107 erode, the further each movable conductor 105 needs to travel toward the corresponding stationary conductor 104 in order to maintain the same degree of physical contact and electrical conductivity between the separable contacts 106, 107. The closer each movable conductor 105 is disposed to the corresponding stationary conductor 104, the closer the adjacent Thomson coil 117 will be positioned to its corresponding conductive plate 116. Thus, the initial 0.030-inch gap between each Thomson coil 117 and corresponding conductive plate 116 will lessen as the adjacent movable conductors 105 travel further toward the stationary conductors 104. Each Thomson coil arrangement 114 will still be serviceable as long as a gap can be maintained between the Thomson coil 117 and conductive plate 116.

In addition, the insulating cylinder 110 is structured to be installed within the circuit interrupter housing such that its longitudinal axis 1 (numbered in FIGS. 2A and 3A) remains fixed in space with respect to the circuit interrupter housing while enabling the insulating cylinder 110 to rotate about its longitudinal axis 1. In FIGS. 2A3A, the directions of rotation clockwise (“CW”) and counterclockwise (“CCW”) about axis 1 are labeled. The structures that keep the insulating cylinder 110 fixedly positioned within the circuit interrupter housing also are not shown in the figures for clarity of illustration.

The rotary TC actuator 100 is designed to include one fewer Thomson coil arrangement 114 than there are poles. As such, the two-pole embodiment 100 of the rotary TC arrangement shown in FIGS. 1-3B includes one Thomson coil arrangement 114, while the three-pole embodiment 100′ shown in FIG. 4 includes two Thomson coil arrangements 114. Each Thomson coil arrangement 114 is positioned between two rotating conductive arms 105. In each Thomson coil arrangement 114, a first of the Thomson coils 117 is positioned to face a first side of the conductive plate 116, and a second of the Thomson coils 117 is positioned to face a second side of the conductive plate 116, the second side of the conductive plate 116 being disposed opposite the first side. In addition, the first Thomson coil 117 is positioned to face a first end of the conductive plate 116 (e.g. the end of the conductive plate 116 extending out the first side 113A of the plate receiving slot 113 in FIG. 3A), and the second Thomson coil 117 is positioned to face a second end of the conductive plate 116 (e.g. the end of the conductive plate 116 extending out the second side 113B of the plate receiving slot 113 in FIG. 3A).

When the rotating conductive arms 105 are in the closed state and the Thomson coils 117 are energized (energization of the Thomson coils being detailed later in connection with FIG. 5), a magnetic field is generated around each Thomson coil 117, causing each Thomson coil 117 to repel the corresponding conductive plate 116 that the Thomson coil 117 faces. Within a given Thomson coil arrangement 114, the repulsion force exerted by the Thomson coils 117 upon the conductive plate 116 causes the conductive plate 116 to rotate (in the view shown in FIGS. 1-3B, the direction of rotation is clockwise, as marked in FIGS. 1 and 2A and 3A). The rotation moves each rotating conductive arm 105 to its open state, thus separating all of the movable separable contacts 107 from their corresponding stationary separable contacts 106. For each Thomson coil arrangement 114, positioning one Thomson coil 117 to face a first side of the conductive plate 116 and positioning the other Thomson coil 117 to face a second side of the given conductive plate 116 provides a counterbalance that enables the repulsion forces generated by each Thomson coil 117 to have an additive effect, such that each individual Thomson coil 117 can generate less repulsion force than a single Thomson coil working alone would have to generate in order to rotate the insulating cylinder 110 the same rotational distance.

As detailed later in conjunction with FIG. 5, the rotary TC actuator 100 is designed to ensure that all of the Thomson coils 117 are energized simultaneously so that all of the rotating conductive arms 105 move simultaneously between the closed state and the open state. As such, the terms “closed position” and “open position” are used hereinafter to refer to dispositions of the other components of the TC actuator 100 that correspond to the rotating conductive arms 105 being in the closed state or open state. For example and without limitation, the insulating cylinder 110 can be described as being in a closed position when the rotating conductive arms 105 are in the closed state. Similarly, the insulating cylinder 110 can be described as being in an open position when the rotating conductive arms 105 are in the open state.

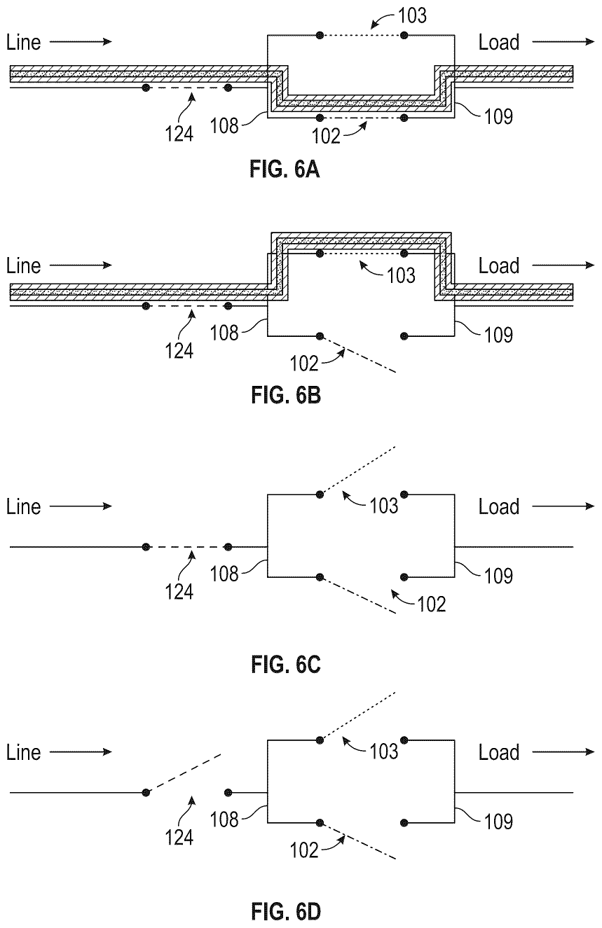

From the foregoing description of the components of the rotary TC actuator 100, it should be understood that each pole assembly 101 comprises its own mechanical branch 102 and power electronics branch 103 but that the insulating cylinder 110 and the Thomson coil arrangements 114 are common to all poles. Each pole assembly 101 further comprises its own galvanic isolation bypass relay 124, detailed further in conjunction with FIGS. 5 and 6A-6D.

A brief explanation of how the rotary TC actuator 100 functions to interrupt power within a circuit interrupter is now provided referencing FIG. 5 in conjunction with FIGS. 1-3B. FIG. 5 is a block diagram of a multi-pole hybrid circuit interrupter 201 (e.g., without limitation, a circuit breaker) in which the rotary TC actuator 100 can be used to open the separable contacts of all poles simultaneously, in accordance with an example embodiment of the disclosed concept. The multi-pole hybrid circuit interrupter 201 depicted in FIG. 5 is a two-pole interrupter having a Line A and a Line B, and the letters “A” and “B” are appended to the reference numbers for certain components in FIG. 5 in order to denote that the component is connected respectively to Line A or Line B. For case of illustration, only the pole assembly 101A of the rotary TC actuator 100 is shown in detail in FIG. 5, however, the other pole assembly 101B shown in FIG. 1 should be understood to include all of the same components as the pole assembly 101 connected to line A, as previously stated and as depicted in FIGS. 1-3B.

As shown in FIG. 5, each pole assembly 101 is structured to be electrically connected between a power source 203 and a load 204 via a line conductor 205. The mechanical branch 102 and the power electronics branch 103 of each pole assembly 101 form a hybrid switch assembly 206. The circuit interrupter 201 is structured to trip and switch open the hybrid switch assembly 206 of each pole in order to interrupt current flowing between the power source 203 and load 204 in the event of a fault condition (e.g., without limitation, an overcurrent condition). The circuit interrupter 201 further includes a trip unit 208 that is structured to monitor power flowing through each pole assembly 101 via a current sensor 210 and/or other sensors and to detect fault conditions based on the power flowing through each pole assembly 101 via its corresponding line conductor 205.

Within each pole assembly 101, under normal operating conditions, the separable contacts 106, 107 of the mechanical branch 102 are closed and the power electronics branch 103 is switched off. The trip unit 208 is configured to energize all of the Thomson coils 117 of the rotary TC actuator 100 in response to detecting a fault condition in any one of the poles. For example and without limitation, the rotary TC actuator 100 can include a capacitor for each of the Thomson coils 117, with each capacitor being connected to its corresponding Thomson coil 117, and the trip unit 208 can be configured to discharge the capacitors in order to energize the Thomson coils 218. As previously discussed, when the Thomson coils 117 are energized, each Thomson coil 117 repels the corresponding conductive plate 116 that the Thomson coil 117 faces, causing the conductive plate 116 to rotate the insulating cylinder 110 to its open position (as previously noted, in the view shown in FIGS. 1-3B, the direction of rotation is clockwise, as marked in FIGS. 1 and 2A and 3A). It is noted that the insulating cylinder 110 will still rotate to its open position if fewer than all Thomson coils 117 are energized, but the rotation would occur at a slower speed. That is, each Thomson coil arrangement 114 is structured such that the conductive plate 116 will move away from the two Thomson coils 117 when at least one of the two Thomson coils 117 is energized with current.

As both pairs of separable contacts 106, 107 within each pole assembly 101 are separating, an arc voltage develops. It is noted that two arcs are created within each pole assembly 101, one for each pair of separable contacts 106, 107. Within each pole assembly 101, the arc voltage commutates current to the power electronics branch 103, switching on the power electronics branch 103. It is noted that the arc voltage generated by the two pairs of separable contacts 106, 107 within each pole assembly 101 is larger than the arc voltage would be if each pole assembly 101 only included one pair of separable contacts 106, 107. A short time later, a control circuit in the trip unit 208 switches off the power electronics branch 103 in order to fully interrupt the flow of current through the hybrid switch assembly 206. When galvanic isolation is desired, each galvanic isolation bypass relay 124 is opened after current through each hybrid switch assembly 206 has been fully interrupted (i.e. after the mechanical branch 102 has been opened and the power electronics branch 103 has been switched off).

Reference is now made to FIGS. 6A-6D in conjunction with FIGS. 1-5. FIGS. 6A-6C show schematic diagrams of the different stages of current interruption in one pole assembly 101, in accordance with an exemplary embodiment of the disclosed concept. FIG. 6A depicts normal operation of the circuit interrupter, wherein the galvanic isolation bypass relay 124 is closed and the mechanical branch 102 is closed, such that current flows from the power source 203 (FIG. 5) through the mechanical branch 102 to the load 204 (FIG. 5). It is noted that, although the power electronics branch 103 is depicted as closed in FIG. 6A, current does not flow through the power electronics branch 103 when the mechanical branch 102 is closed, because the resistance of the mechanical branch is functionally zero, while the power electronics branch 103 has a non-trivial resistance.

FIG. 6B depicts the initial stage of current interruption after a fault condition has been detected. In FIG. 6B, the mechanical branch 102 is open (i.e. the separable contacts 106, 107 have separated) due to the Thomson coils 117 having been energized by the electronic trip unit 208, and current has commutated to the power electronics branch 103 after an arc voltage has developed across the mechanical branch 102 due to the separation of the mechanical contacts 106, 107. FIG. 6C depicts the second stage of current interruption, wherein the electronic trip unit 208 has switched off the power electronics branch 103 in order to fully interrupt the current flowing through the pole assembly 101. FIG. 6D depicts galvanic isolation, wherein the galvanic isolation bypass relay 124 has been opened after the flow of current through the hybrid switch assembly 206 has been fully interrupted.

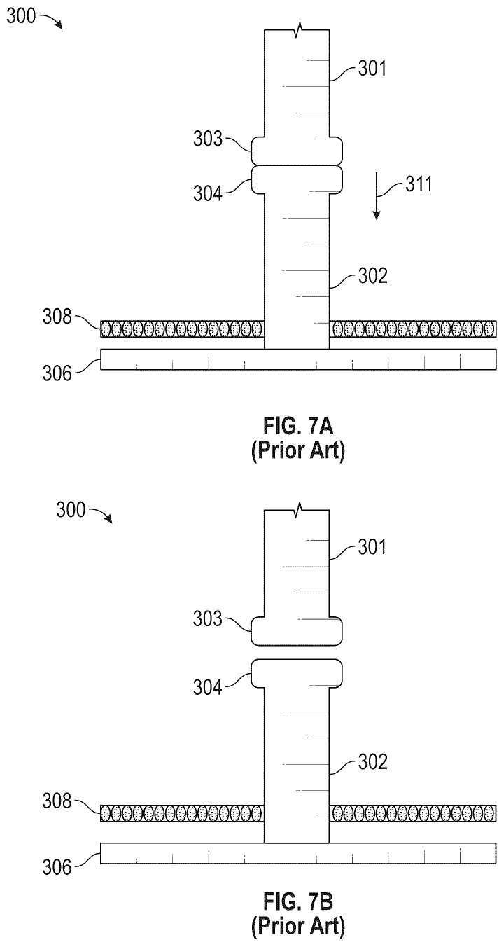

In order to appreciate the advantages of the disclosed rotary TC actuator 100, a brief discussion of known Thomson coil actuators is now provided. Known Thomson coil actuators typically utilize linear motion to separate the mechanical separable contacts of a circuit interrupter, with a simplified representative example being shown in FIGS. 7A and 7B. A prior art Thomson coil actuator 300 (referred to hereinafter as the “TC actuator 300” for brevity) is shown in partial sectional view in FIGS. 7A and 7B. The TC actuator 300 comprises a stationary conductor 301 and a movable conductor 302, with the stationary conductor 301 including a stationary separable contact 303 and the movable conductor 302 including a movable separable contact 304. The stationary conductor 301 is configured to remain fixed in position, while the movable conductor 302 is configured to move between a closed state shown in FIG. 7A and an open state shown in FIG. 7B. In the closed state, the movable separable contact 304 is in physical contact with and electrically connected to the stationary separable contact 303. In the open state, the movable separable contact 304 is physically separated from and electrically isolated from the stationary separable contact 303.

Continuing to refer to FIGS. 7A and 7B, a conductive plate 306 is fixedly coupled to the movable conductor 302. A Thomson coil 308 comprising a central opening is fixed in position with the movable conductor 302 disposed through the central opening such that the Thomson coil 308 and the conductive plate 306 face one another. The Thomson coil 308 is configured to receive current in order to be energized (for example, when a fault condition is detected in the associated circuit interrupter). When the movable conductor 302 is in the closed state and the Thomson coil 308 is energized, a magnetic field is generated around the Thomson coil 308, causing the Thomson coil 308 to repel the conductive plate 306. The repulsion force exerted by the Thomson coil 308 upon the conductive plate 306 causes the conductive plate 306 to move the movable conductor 302 away from stationary conductor 301 (i.e. in the linear direction indicated by the arrow 311 in FIG. 7A) and into the open state. It is noted that there are typically several other movable components associated with and coupled to the movable conductor 302 (such as the components of a drive assembly) that also get moved when the movable conductor 302 is moved by the repulsion between the Thomson coil 308 and the conductive plate 306.

The disclosed rotary TC actuator 100 provides several advantages over known Thomson coil actuators such as the known TC actuator 300 depicted in FIGS. 7A-7B. In a typical circuit interrupter using a linear Thomson coil arrangement, the greatest impediment to a movable conductor being able to move from the closed state to the open state more quickly is the mass of all of the components that need to be moved (i.e. the movable conductor and any other components coupled to the movable conductor, such as the components of a drive assembly). The arm shape of the rotating conductive arms 105 in the rotary design utilizes significantly less material than the cylindrical shape of a typical movable conductor (such as the movable conductor 302 in FIGS. 7A-7B), and the polymer from which the insulating cylinder 110 is made is relatively very lightweight, resulting in the moving components of the rotary TC actuator 100 having significantly less mass than the moving components of a typical linear Thomson coil actuator arrangement (such as the prior art TC actuator 300). The opposing orientations of the two Thomson coils 117 relative to the conductive plate 116 in each Thomson coil arrangement 114 also results in the repulsion force exerted by each of the two coils 117 on the conductive plate 116 being additive.

In addition, the rotary design of the disclosed rotary TC actuator 100 is significantly more compact than a corresponding linear design and results in a significantly smaller footprint. Although not shown in FIGS. 7A and 7B, circuit interrupters with linear Thomson coil actuators typically include a contact spring that helps mitigate some of the impact that occurs from the movable conductor and the other associated movable components being moved to the open state at high speeds. This requires the movable conductor to have to travel a minimum distance and at a minimum velocity to overcome the spring force, which can result in overtravel. However, the rotary design of the disclosed rotary TC actuator 100 avoids the issue of having to overcome the spring force altogether, as the lesser mass of the movable components of the rotary TC actuator 100 eliminates the need for a contact spring. The relatively small size of each Thomson coil 117 and the relatively low capacitance needed to energize each Thomson coil 117 results in the LC time constant being relatively small, so the rise time for the current (and resulting electromagnetic forces) is very short. Preliminary calculations indicate that using a 410V, 0.47 millifarad capacitor for each coil 117 (18 AWG, 10 turns) will create 4.7 degrees of rotation in 200 microseconds. That creates enough of a gap between each pair of the separable contacts 106, 107 (6 mm of additive gap distance per Thomson coil arrangement 114, i.e. 3 mm per each pair of contacts 106, 107) to prevent an immediate restrike. Furthermore, the modular design of the rotary TC actuator 100 makes it easy to adapt for use with varying numbers of poles, since the insulating cylinder 110 only needs to be formed with a different number of plate receiving slots 113 in order to accommodate varying numbers of conductive plates 116.

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of disclosed concept which is to be given the full breadth of the claims appended and any and all equivalents thereof.

What is claimed is:

1. A rotary Thomson coil actuator for use in a multi-pole circuit interrupter, the circuit interrupter including a plurality of poles, the rotary Thomson coil actuator comprising:
an insulating cylinder;
a plurality of pole assemblies disposed between a line side and a load side of the rotary Thomson coil actuator, each pole assembly comprising:
two stationary conductors, each stationary conductor being fixed in space and including a stationary contact; and
one rotating conductive arm, the rotating conductive arm being fixedly coupled to the insulating cylinder and comprising two movable contacts, with each movable contact corresponding to one of the stationary contacts; and
a number of Thomson coil arrangements, the number of Thomson coil arrangements being one less in quantity than the plurality of pole assemblies, each Thomson coil arrangement comprising:
a conductive plate, the conductive plate being fixedly coupled to the insulating cylinder; and
two Thomson coils including a first Thomson coil and a second Thomson coil, the two Thomson coils being fixed in space and facing the conductive plate,
wherein the insulating cylinder is configured to rotate between a closed position and an open position, the closed position being a position in which all of the movable contacts are in physical and electrical contact with their corresponding stationary contacts, and the open position being a position in which all of the movable contacts are physically separated and electrically isolated from their corresponding stationary contacts,
wherein each Thomson coil arrangement is structured such that the conductive plate moves away from the two Thomson coils when at least one of the two Thomson coils is energized with current, and
wherein each Thomson coil arrangement is structured such that energizing the Thomson coils with current causes the insulating cylinder to rotate from the closed position to the open position.

2. The rotary Thomson coil actuator of claim 1,
wherein, for each Thomson coil arrangement, the first Thomson coil is positioned to face a corresponding first end of the conductive plate and the second Thomson coil is positioned to be face a corresponding second end of the conductive plate disposed opposite the first end.

3. The rotary Thomson coil actuator of claim 1,
wherein for each Thomson coil arrangement, the first Thomson coil is positioned to face a corresponding first surface of the conductive plate and the second Thomson coil is positioned to face a corresponding second surface of the conductive plate disposed opposite the first surface.

4. The rotary Thomson coil actuator of claim 1,
wherein the insulating cylinder comprises a number of plate receiving slots,
wherein, for each Thomson coil arrangement, the conductive plate is inserted into a corresponding one of the number of plate receiving slots, such that a first end of the conductive plate extends out a first side of the corresponding plate receiving slot and such that a second end of the conductive plate extends out a second side of the corresponding plate receiving slot, with the first end of the conductive plate being symmetrical with the second end of the conductive plate.

5. The rotary Thomson coil actuator of claim 1,
wherein the insulating cylinder comprises a plurality of arm receiving slots,
wherein, for each Thomson coil arrangement and for each rotating conductive arm, the rotating conductive arm is inserted into a corresponding one of the arm receiving slots, such that a first end of the rotating conductive arm extends out a first side of the corresponding arm receiving slot and such that a second end of the rotating conductive arm extends out a second side of the corresponding arm receiving slot, with the first end of the rotating conductive arm being symmetrical with the second end of the rotating conductive arm.

6. The rotary Thomson coil actuator of claim 4,
wherein the insulating cylinder comprises a longitudinal axis, two bases disposed parallel to one another, and a curved surface extending between the two bases,
wherein each plate receiving slot is centrally positioned relative to a length of the insulating cylinder, extending through a cross section of the insulating cylinder and coinciding with the longitudinal axis, and
wherein each plate receiving slot forms two openings in the curved surface of the insulating cylinder.

7. The rotary Thomson coil actuator of claim 5,
wherein the insulating cylinder comprises a longitudinal axis, two bases disposed parallel to one another, and a curved surface extending between the two bases,
wherein a plurality of flattened regions are formed in the curved surface,
wherein the plurality of flattened regions includes at least a first pair of peripheral flattened regions positioned adjacent to a first base of the two bases and a second pair of peripheral flattened regions positioned adjacent to a second base of the two bases,
wherein each arm receiving slot is positioned in one of the flattened regions and extends through a cross section of the insulating cylinder so as to coincide with the longitudinal axis, and
wherein each arm receiving slot forms two openings in the corresponding flattened region.

8. The rotary Thomson coil actuator of claim 1,
wherein each Thomson coil arrangement is configured to rotate the insulating cylinder about a longitudinal axis of the insulating cylinder.

9. The rotary Thomson coil actuator of claim 1,
wherein each pole assembly further comprises a power electronics branch,
wherein, within each pole assembly, the two stationary conductors and the rotating conductive arm forms a mechanical branch, and the power electronics branch is connected in parallel with the mechanical branch between the line side and the load side, and
wherein each pole assembly is configured to conduct current through only the mechanical branch under normal operating conditions, and to commutate current from the mechanical branch to the power electronics branch during a fault condition.

10. The rotary Thomson coil actuator of claim 9,
wherein each pole assembly further comprises a galvanic isolation switch, the galvanic isolation switch being configured to conduct current under normal operating conditions, and
wherein, within each pole assembly:
the mechanical branch and the power electronics branch form a hybrid switch assembly,
the galvanic isolation switch is connected in series with the hybrid switch assembly between the line side and the load side,
the power electronics branch is configured to switch off after current has been commutated to the power electronics branch, and
when current is commutated to the power electronics branch, the galvanic isolation switch is configured to switch open after the power electronics branch has switched off.

11. A circuit interrupter with a plurality of poles structured to be connected between a power source and a load, the circuit interrupter comprising:
an electronic trip unit; and
a rotary Thomson coil actuator, the rotary Thomson coil actuator comprising:
an insulating cylinder;
a plurality of pole assemblies disposed between a line side and a load side of the rotary Thomson coil actuator, each pole assembly comprising:
two stationary conductors, each stationary conductor being fixed in space and including a stationary contact; and
one rotating conductive arm, the rotating conductive arm being fixedly coupled to the insulating cylinder and comprising two movable contacts, with each movable contact corresponding to one of the stationary contacts; and
a number of Thomson coil arrangements, the number of Thomson coil arrangements being one less in quantity than the plurality of pole assemblies, each Thomson coil arrangement comprising:
a conductive plate, the conductive plate being fixedly coupled to the insulating cylinder; and
two Thomson coils including a first Thomson coil and a second Thomson coil, the two Thomson coils being fixed in space and facing the conductive plate,
wherein the insulating cylinder is configured to rotate between a closed position and an open position, the closed position being a position in which all of the movable contacts are in physical and electrical contact with their corresponding stationary contacts, and the open position being a position in which all of the movable contacts are physically separated and electrical isolated from their corresponding stationary contacts,
wherein the electronic trip unit is configured to energize all of the Thomson coils in the rotary Thomson coil actuator when a fault condition is detected in any of the poles,
wherein each Thomson coil arrangement is structured such that the conductive plate moves away from the two Thomson coils when at least one of the two Thomson coils is energized with current, and
wherein the rotary TC arrangement is structured such that energizing at least one of the Thomson coils with current causes the insulating cylinder to rotate from the closed position to the open position.

12. The circuit interrupter of claim 11,
wherein, for each Thomson coil arrangement, the first Thomson coil is positioned to face a corresponding first end of the conductive plate and the second Thomson coil is positioned to be face a corresponding second end of the conductive plate disposed opposite the first end.

13. The circuit interrupter of claim 11,
wherein for each Thomson coil arrangement, the first Thomson coil is positioned to face a corresponding first surface of the conductive plate and the second Thomson coil is positioned to face a corresponding second surface of the conductive plate disposed opposite the first surface.

14. The circuit interrupter of claim 11,
wherein the insulating cylinder comprises a number of plate receiving slots,
wherein, for each Thomson coil arrangement, the conductive plate is inserted into a corresponding one of the number of plate receiving slots, such that a first end of the conductive plate extends out a first side of the corresponding plate receiving slot and such that a second end of the conductive plate extends out a second side of the corresponding plate receiving slot, with the first end of the conductive plate being symmetrical with the second end of the conductive plate.

15. The circuit interrupter of claim 11,
wherein the insulating cylinder comprises a plurality of arm receiving slots,
wherein, for each Thomson coil arrangement and for each rotating conductive arm, the rotating conductive arm is inserted into a corresponding one of the arm receiving slots, such that a first end of the rotating conductive arm extends out a first side of the corresponding arm receiving slot and such that a second end of the rotating conductive arm extends out a second side of the corresponding arm receiving slot, with the first end of the rotating conductive arm being symmetrical with the second end of the rotating conductive arm.

16. The circuit interrupter of claim 14,
wherein the insulating cylinder comprises a longitudinal axis, two bases, and a curved surface extending between the two bases,
wherein each plate receiving slot is centrally positioned relative to a length of the insulating cylinder, extending through a cross section of the insulating cylinder and coinciding with the longitudinal axis, and
wherein each plate receiving slot forms two openings in the curved surface of the insulating cylinder.

17. The circuit interrupter of claim 15,
wherein the insulating cylinder comprises a longitudinal axis, two bases disposed parallel to one another, and a curved surface extending between the two bases,
wherein a plurality of flattened regions are formed in the curved surface,
wherein the plurality of flattened regions includes at least a first pair of peripheral flattened regions positioned adjacent to a first base of the two bases and a second pair of peripheral flattened regions positioned adjacent to a second base of the two bases,
wherein each arm receiving slot is positioned in one of the flattened regions and extends through a cross section of the insulating cylinder so as to coincide with the longitudinal axis, and
wherein each arm receiving slot forms two openings in the corresponding flattened region.

18. The circuit interrupter of claim 11,
wherein each Thomson coil arrangement is configured to rotate the insulating cylinder about a longitudinal axis of the insulating cylinder.

19. The circuit interrupter of claim 11,
wherein each pole assembly further comprises a power electronics branch,
wherein, within each pole assembly, the two stationary conductors and the rotating conductive arm forms a mechanical branch, and the power electronics branch is connected in parallel with the mechanical branch between the line side and the load side, and
wherein each pole assembly is configured to conduct current through only the mechanical branch under normal operating conditions, and to commutate current from the mechanical branch to the power electronics branch during a fault condition.

20. The circuit interrupter of claim 19,
wherein each pole assembly further comprises a galvanic isolation switch, the galvanic isolation switch being configured to conduct current under normal operating conditions, and
wherein, within each pole assembly:
the mechanical branch and the power electronics branch form a hybrid switch assembly,
the galvanic isolation switch is connected in series with the hybrid switch assembly between the line side and the load side,
the power electronics branch is configured to switch off after current has been commutated to the power electronics branch, and
when current is commutated to the power electronics branch, the galvanic isolation switch is configured to switch open after the power electronics branch has switched off.
